(19) United States
(12) Patent Application Publication
(10) Pub. No.: US 2004/0022263 A1
(43) Pub. Date: Feb. 5, 2004

(54) Cross point switch with out-of-band parameter fine tuning

(76) Inventors: Xiaodong Zhao, Cupertino, CA (US); Ming G. Wong, San Jose, CA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/210,041

(22) Filed: Aug. 2, 2002

(51) Int. Cl. H04L 12/43

(52) U.S. Cl. 370/461; 370/447; 370/462

(57) ABSTRACT

A digital switch includes a switching fabric that switches data between a plurality of ports. The switching fabric includes data lines and a control line. An arbitrator arbitrates traffic between the plurality of ports. A command processor receives a command over the control line and modifies a switching fabric parameter in response to the command. The control line is preferably the same line that is not used during normal switching fabric operation, such as, for example, an ABORT line, or ABORT pin.

### CROSS-REFERENCE TO RELATED APPLICATIONS

This application is related to application Ser. No. ______ , filed on even date herewith, entitled CROSS POINT SWITCH WITH DEADLOCK PREVENTION, Inventors: Ming G. Wong and Xiaodong Zhao, Attorney Docket No. 1988.0130000, which is incorporated by reference herein.

### BACKGROUND OF THE INVENTION

1. Field of the Invention

The present invention relates to data switches, and more particularly, to data switches whose parameters may be changed during operation using out-of-band control signals.

2. Related Art

A network switch is a device that provides a switching function (i.e., determines a physical path) in a data communications network. Switching involves transferring information, such as digital data packets or frames, among entities of the network. Typically, a switch is a computer having a plurality of circuit cards coupled to a backplane. In the switching art, the circuit cards are typically called “blades.” The blades are interconnected by a “switch fabric” or “switching fabric,” which is a switchable interconnection between blades. The switch fabric can be located on a backplane, a blade, more than one blade, a separate unit from the blades, or on any combination thereof. Each blade includes a number of physical ports that couple the switch to other network entities over various types of media, such as coaxial cable, twisted-pair wire, optical fibers, or a wireless connection, using a communication protocol such as Ethernet, FDDI (Fiber Distributed Data Interface), or token ring. A network entity includes any device that transmits and/or receives data packets over such media.

The switching function provided by the switch typically includes receiving data at a source port from a network entity and transferring the data to a destination port. The source and destination ports may be located on the same or different blades. In the case of “local” switching, the source and destination ports are on the same blade. Otherwise, the source and destination ports are on different blades and switching requires that the data be transferred through the switch fabric from the source blade to the destination blade. In some cases, the data may be provided to a plurality of destination ports of the switch. This is known as a multicast data transfer.

Switches operate by examining the header information that accompanies data in the data frame. In some communications protocols, the header information is structured in accordance with the International Standards Organization (ISO) 7-layer OSI (open-systems interconnection) model. In the OSI model, switches generally route data frames based on the lower level protocols such as Layer 2. In contrast, routers generally route based on the higher level protocols such as Layer 3 and by determining the physical path of a data frame based on table look-ups or other configured forwarding or management routines to determine the physical path (i.e., route).

Ethernet is a widely used lower-layer network protocol that uses broadcast technology. The Ethernet frame has six fields. These fields include a preamble, a destination address, source address, type, data and a frame check sequence. In the case of an Ethernet frame, a digital switch will determine the physical path of the frame based on the source and destination addresses.

A particular problem exists in many digital switch configurations in that it is desirable to change the properties of the digital switch (i.e., fine tune digital switch parameters) during operation. For example, it may be desirable to change the arbitration parameters, such as packet priority, port priority, store and forward arbitration parameters, or cut-through arbitration parameters. Additionally, it may be desirable to change lockup timeout parameters, as described in related application Ser. No. ______ , filed on even date herewith, entitled CROSS POINT SWITCH WITH DEADLOCK PREVENTION, Inventors: Xiaodong Zhao and Ming G. Wong, Attorney Docket No. 1988.0130000, which is incorporated by reference herein. An example of a lockup is the following situation:

A problem of deadlock (also known as lock up, or hang up, or deadly embrace) exists in virtually all modern digital switches. Typical digital switches include multiple ports, each one of which can transmit data to any one of the other ports. Each port has a FIFO (First In, First Out structure), sometimes multiple FIFOs. The switching fabric also typically contains multiple FIFOs, and is responsible for managing and arbitrating data transfer between the various ports. A condition that may occur, particularly during heavy utilization of multiple ports of the same switching fabric, is that as the FIFOs fill up with outgoing data, each port is simultaneously waiting for another port to be allowed to transmit data to that port through the digital switch. For example, port A is waiting for port B, port B is waiting for port C, port C is waiting for port D, and port D is waiting for port A (in a 4 port example). This situation, which is most likely to occur during heavy traffic conditions, is referred to as a deadlock, a “deadly embrace,” or a “lockup.”

However, in practical systems, the number of pins, or control lines, for transmission of such commands that modify the parameters from a controller (e.g., a master blade) to the switching fabric is finite, and it is desirable to be able to change such parameters without increasing the number of pins, or doing a complete redesign of the switching device so as to add additional control lines.

### SUMMARY OF THE INVENTION

The present invention is directed to a cross point switch with out-of-band parameter fine tuning that substantially obviates one or more of the problems and disadvantages of the related art.

There is provided a method of fine tuning a digital switch including the steps of monitoring a control pin of the digital switch, detecting a change in a state of the control pin, analyzing that state of the control pin to determine if a command is present within a predetermined time window, and modifying a parameter of the digital switch in response to the command.

In another aspect there is provided a digital switch including a switching fabric that switches data between a plurality of ports, the switching fabric including data lines and a control line, an arbitrator that arbitrates traffic between the plurality of ports, and a command processor that receives a command over the control line and modifies a switching fabric parameter in response to the command.

Additional features and advantages of the invention will be set forth in the description that follows. Yet further features and advantages will be apparent to a person skilled in the art based on the description set forth herein or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram of a high-performance network switch according to an embodiment of the present invention.

FIG. 2 is a diagram of a high-performance network switch showing a switching fabric having cross point switches coupled to blades according to an embodiment of the present invention.

FIG. 3 is a diagram of a blade used in the high-performance network switch of FIG. 1 according to an embodiment of the present invention.

FIG. 4 is a diagram of the architecture of a cross point switch with port slices according to an embodiment of the present invention.

FIG. 5 shows a somewhat simplified schematic of a cross point 15 (XPNT15) slice.

FIG. 6 shows a somewhat simplified schematic of a cross point 8 (XPNT8) slice.

FIG. 7 illustrates the cross point architecture of cross point slices connected to a CPU.

FIG. 8 illustrates hot unplug glitches.

FIG. 9 illustrates a command using a time window and a control line.

FIG. 10 illustrates two sequential commands using the control line.

FIGS. 11-12 illustrate operation of a finite state machine with a sliding time window of one embodiment of the present invention.

FIG. 13 illustrates possible commands that may be transmitted using the control pin.

### DETAILED DESCRIPTION OF THE INVENTION

Reference will now be made in detail to the embodiments of the present invention, examples of which are illustrated in the accompanying drawings.

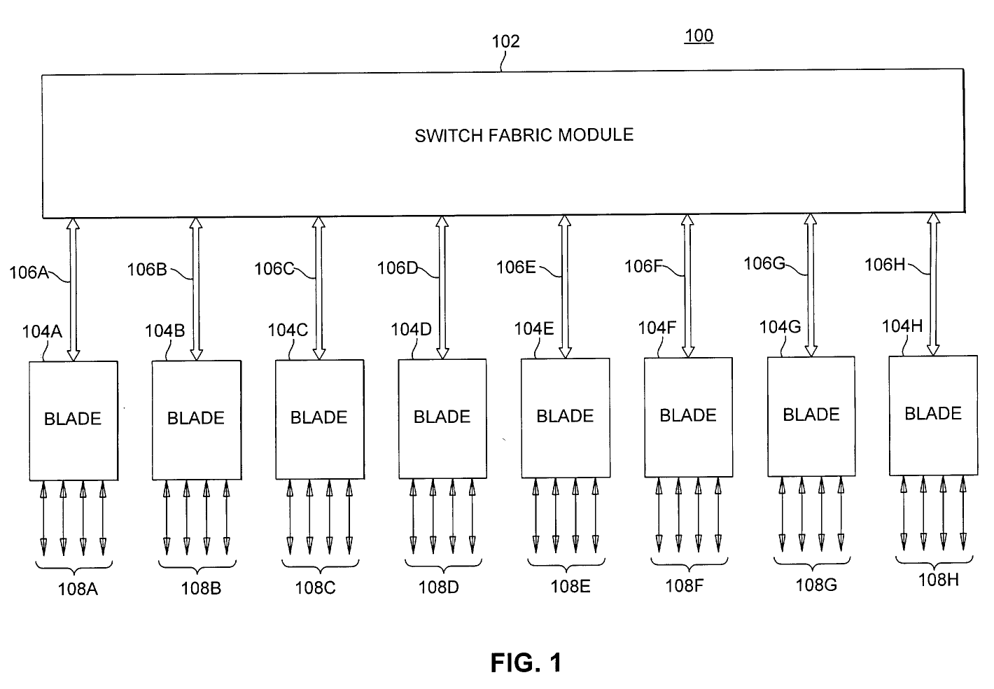

An overview of the architecture of one embodiment of a digital switch 100 of the invention is illustrated in FIG. 1. Digital switch 100 includes a switch fabric 102 (also called a switching fabric or switching fabric module) and a plurality of blades 104 (only eight blades are shown in FIG. 1 for clarity). In one embodiment of the invention, digital switch 100 includes blades 104A-104H. Each blade 104 communicates with switch fabric 102 via pipe 106. Each blade 104 further includes a plurality of physical ports 108 for receiving various types of digital data from one or more network connections.

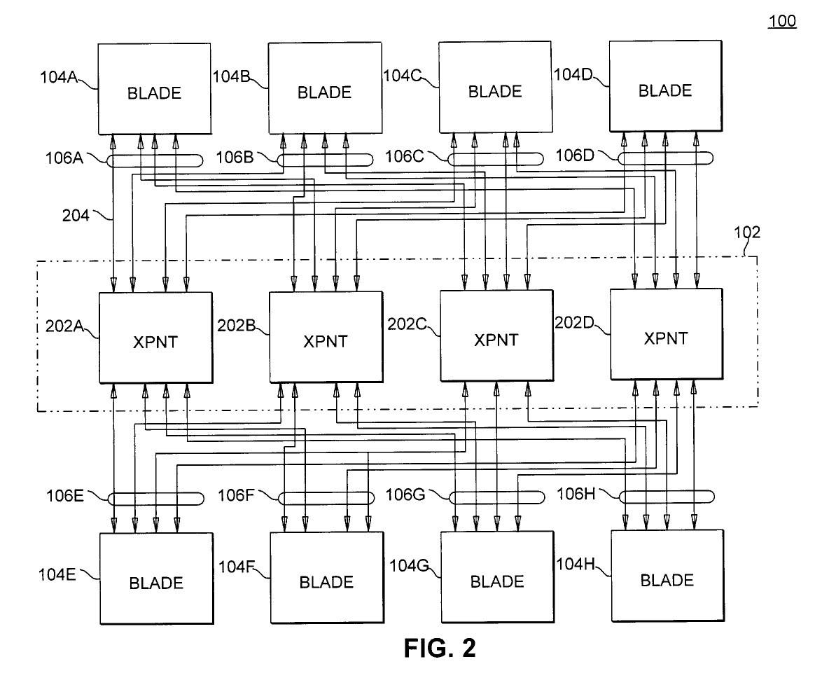

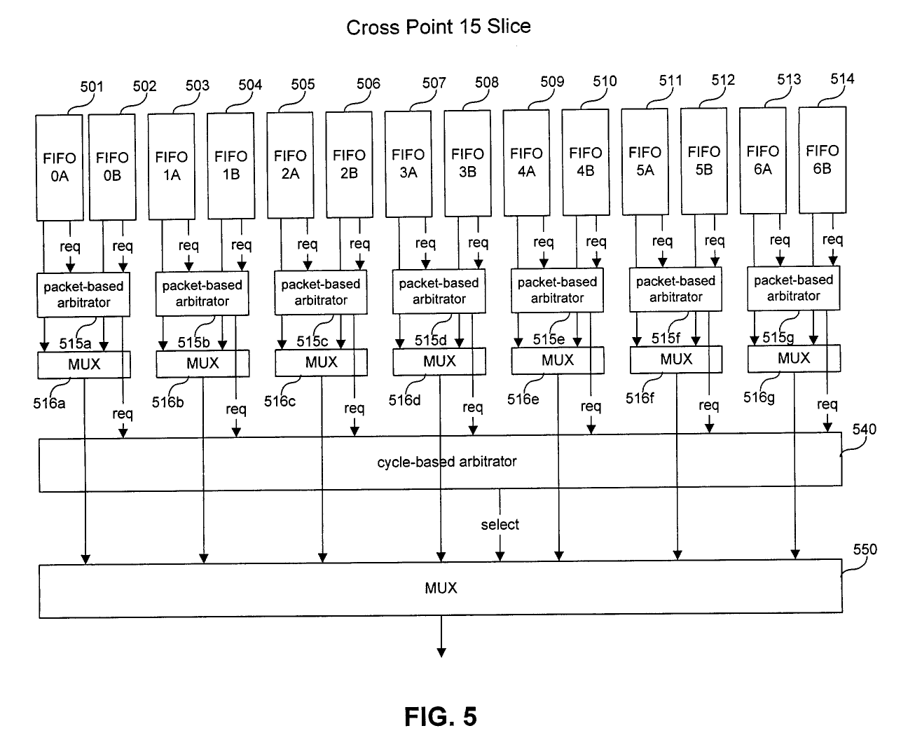

Referring to FIG. 2, switch fabric 102 includes a plurality of cross points (XPNTs) 202. In each cross point 202, there is a set of data structures, such as data FIFOs (First in, First out data structures) (see FIG. 5 and discussion below). The data FIFOs store data based on the source port and the destination port. In one embodiment, for an 8-port cross point, eight data FIFOs are used.

Of the cross points 202A-202D shown in FIG. 2, only a subset may be used in the overall switching fabric. For example, in a “Cross Point 8” (or XPNT8) embodiment for eight blades, only one cross point 202A may be employed. A 15-blade cross point (“Cross Point 15” or XPNT15) may utilize two XPNT8's (e.g., 202A and 202B as a single unit), such that XPNT15 has all the logic of two XPNT8's, plus additional logic. A four-cross point switching fabric may therefore have two XPNT 15's.

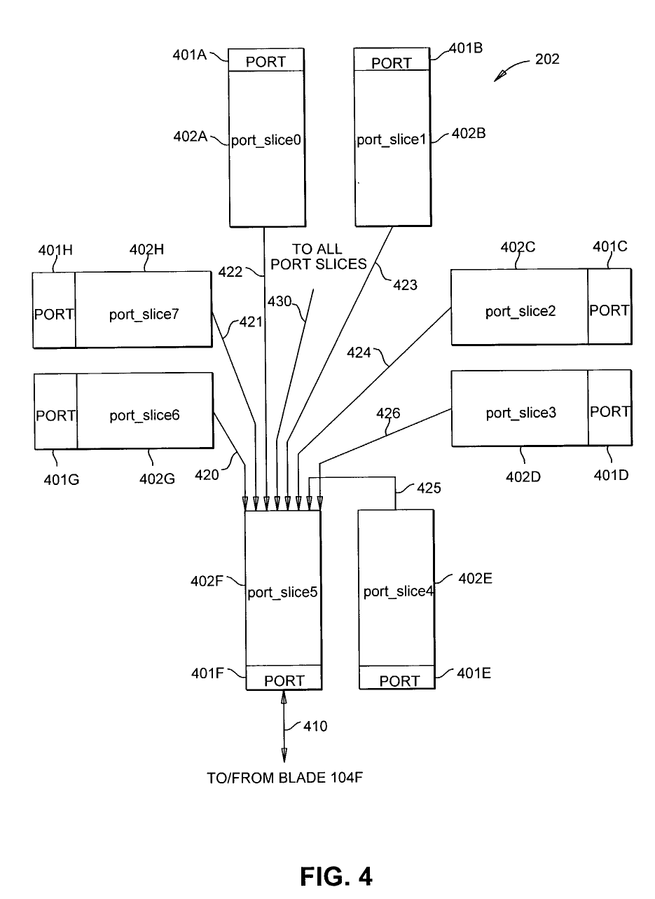

Each data FIFO stores data associated with a respective source port and destination port. Packets coming to each source port are written to the data FIFOs that correspond to a source port and a destination port associated with the packets. The source port is associated with the port (and port slice, see discussion below with reference to FIG. 4 and elements 402A-402H) on which the packets are received. The destination port is associated with a destination port ID (corresponding to a forwarding ID, or FID) or slot number that is found in-band or side-band in data sent to a port.

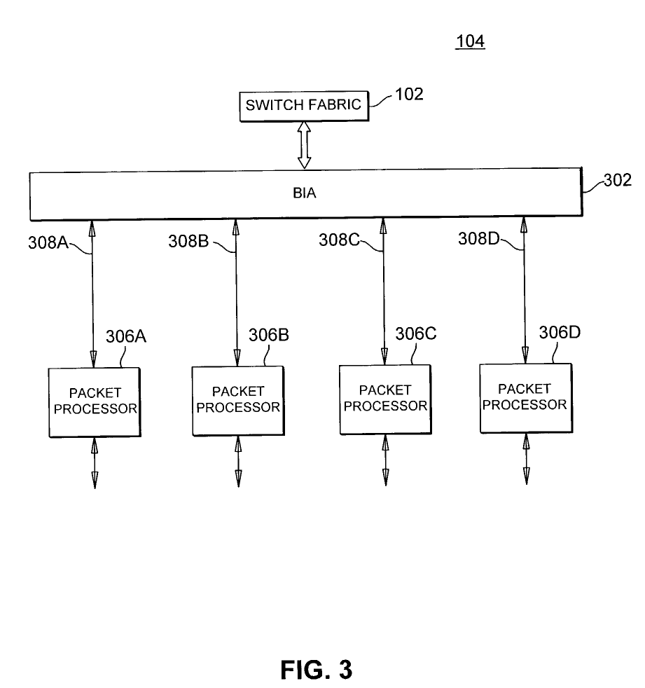

Referring now to FIG. 3, the architecture of a blade 104 is shown in further detail. Blade 104 comprises a backplane interface adapter (BIA) 302 and a plurality of packet processors 306. BIA 302 is responsible for sending the data across the cross point of switch fabric 102. In a preferred embodiment, BIA 302 is implemented as an application-specific circuit (ASIC). BIA 302 receives data from packet processors 306. BIA 302 may pass the data to switch fabric 102 or may perform local switching between the local ports on blade 104.

Each packet processor 306 includes one or more physical ports. Each packet processor 306 receives inbound packets from the one or more physical ports, determines a destination of the inbound packet based on control information, provides local switching for local packets destined for a physical port to which the packet processor is connected, formats packets destined for a remote port to produce parallel data and switches the parallel data to an IBT 304.

In the example illustrated in FIG. 3, packet processors 306C and 306D comprise 24—ten or 100 megabit per second Ethernet ports, and two 1000 megabit per second (i.e., 1 Gb/s) Ethernet ports. Before the data is converted, the input data packets are converted to 32-bit parallel data clocked at 133 MHz. Packets are interleaved to different destination ports.

BIA 302 receives the bit streams from packet processors 306, determines a destination of each inbound packet based on packet header information, provides local switching between local packet processors 306, formats data destined for a remote port, aggregates the bit streams from packet processors 306 and produces an aggregate bit stream. The aggregated bit stream is then sent across the four cross points 202A-202D.

FIG. 4 illustrates the architecture of a cross point 202. Cross point 202 includes eight ports 401A-401H coupled to eight port slices 402A-402H. As illustrated, each port slice 402 is connected by a wire (or other connective media) to each of the other seven port slices 402. Each port slice 402 is also coupled to through a port 401 a respective blade 104. To illustrate this, FIG. 4 shows connections for port 401F and port slice 402F (also referred to as port_slice 5). For example, port 401F is coupled via link 410 to blade 104F.

Port slice 402F is coupled to each of the seven other port slices 402A-402E and 402G-402H through links 420-426. Links 420-426 route data received in the other port slices 402A-402E and 402G-402H that has a destination port number (also called a destination slot number) associated with a port of port slice 402F (i.e. destination port number 5). Finally, port slice 402F includes a link 430 that couples the port associated with port slice 402F to the other seven port slices. Link 430 allows data received at the port of port slice 402F to be sent to the other seven port slices. In one embodiment, each of the links 420-426 and 430 between the port slices are buses to carry data in parallel within the cross point 202. Similar connections (not shown in the interest of clarity) are also provided for each of the other port slices 402A-402E, 402G and 402H.

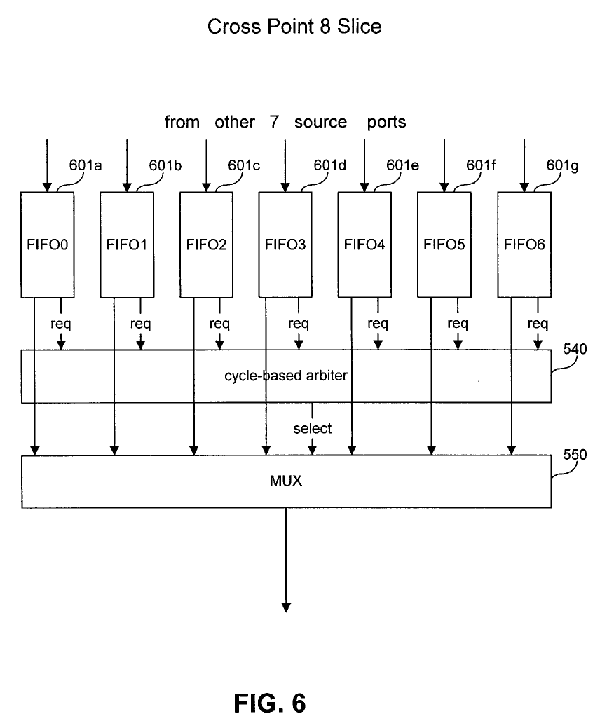

FIG. 6 illustrates a somewhat simplified architecture of one port or slice of a cross point 8 (XPNT8). A XPNT8 is an 8-port switch, in which a packet is switched from each port to any other of seven ports based on a 3-bit slot number in a side channel. As shown in FIG. 6, each port has seven FIFOs 601a-601g to store data coming from the other seven source ports. Note that in FIG. 6, only seven FIFOs (FIFO0-FIFO6) are shown, however, in the actual XPNT8, the number of FIFOs is eight times what is shown in FIG. 6 (i.e., each of the eight ports has seven FIFOs to receive data from the other seven ports). When packets from multiple ports are forwarded to a particular port using cycle-based arbitrator 540 (FIFO read arbitrator 540) and a multiplexer 550, data may be selected from one of the possible seven FIFOs 601a-601g every cycle based on a round-robin arbitration scheme.

FIG. 5 illustrates an architecture of a slice of a XPNT15. Here, a “slice” refers to a 16-bit slice of the XPNT15, which is a 64-bit wide device.

Thus, the XPNT15 has four 16-bit slices.

The XPNT15 logically includes two XPNT8's. Since the XPNT15 allows for only a 3-bit slot number to direct packets to seven destinations, the XPNT15 relies on the upper 2 bits of a 16-bit FID (forwarding, or destination ID) to augment the 3-bit slot number for switching packets between 15 ports (or to 14 other ports from any given source port). Note that when a packet is received, destination address information in the header of the packet is compared to the compare field of a CAM (content addressable memory) to retrieve a forwarding identifier (FID). The FID is used for packet routing and to lookup a port mask that identifies the port or ports to which the packet should be routed.

Each port in the XPNT15 has two groups of seven FIFOs, and each group is responsible for storing data coming from the other seven source ports. The FIFOs are designated 501-514 in FIG. 5, including group A, i.e., FIFOs 501, 503, 505, 507, 509, 511 and 513, and group B, i.e., FIFOs 502, 504, 506, 508, 510, 512, and 514. FIG. 5 also shows that for each FIFO of groups A and B, there is a corresponding packet-based arbitrator 515a-515g. Each FIFO in group A and in FIFO group B (for example, FIFO 501 and FIFO 502) has a corresponding multiplexer, designated 516a-516gin FIG. 5, for selection of either an output of FIFO group A, or an output of FIFO group B. In FIG. 5, FIFOs of the A group (FIFOs 501, 503, 505, 507, 509, 511 and 513) take input from source ports 0-6 and FIFOs of the B group (FIFOs 502, 504, 506, 508, 510, 512, and 514) take input data from source ports 7-13. Note that the request (req) signal from the FIFOs may be for either cut-through arbitration, or for store-and-forward arbitration.

In a stand-alone XPNT8, the FIFO request is cut-through and arbitration is cycle based. Within each XPNT8 of the XPNT15, the FIFO request is cut-through and arbitration is cycle based. Between the two XPNT8's (that make up the XPNT15), the FIFO request can be cut-through or store forward, depending on the packet size. Arbitration between the two XPNT8's is packet-based.

Each data FIFO includes a FIFO controller and FIFO random access memory (RAM) (not shown in the figures). The FIFO controllers are coupled to FIFO cycle based arbitrator 540 and to packet-based arbitrators 515. FIFO RAMs are coupled to a multiplexer 550. Cycle-based arbitrator 540 and packet-based arbitrators 515 are further coupled to multiplexer 550. “Cycle” in this context refers to the system clock cycle, for example, 133 MHz being a system clock frequency. (Note that in an actual implementation, both arbitrators may be implemented as a single integrated circuit, or IC.)

During operation, the FIFO RAMs accumulate data. After a data FIFO RAM has accumulated one cell of data, its corresponding FIFO controller generates a read request to cycle-based arbitrator 540 or to packet-based arbitrators 515. (Here, a cell may be 8 bytes, or FIFO depth for cut-through requests, and one packet for store and forward requests.) Cycle-based arbitrator 540 or packet-based arbitrator 515 processes read requests from the different FIFO controllers in a desired order, such as a round-robin order.

After data is read from one FIFO RAM, cycle-based arbitrator 540 will move on to process the next requesting FIFO controller.

To process a read request, cycle-based arbitrator 540 or packet-based arbitrator 515 switches multiplexer 550 to forward a cell of data from the data FIFO RAM associated with the read request.

In this way, arbitration proceeds to service different requesting FIFO controllers and distribute the forwarding of data received at different source ports. This helps maintain a relatively even but loosely coupled flow of data through cross points 202.

A typical cross point 202 has at least four types of pins, or signal lines, or control lines, between blades 104 and the backplane: control lines, data lines, clock lines, and power lines. The present invention utilizes control lines, particularly control lines that are not used during normal operation, to transmit commands from blade 104 to the backplane of digital switch 100. These commands, which are referred to as “out-of-band” commands, may be transmitted from a “master blade” 104A (see discussion below) to switching fabric 102 to fine-tune its parameters during operation.

An example of a control line that may be used for transmission of an out-of-band command is the ABORT pin. The ABORT pin is normally used only during exceptional circumstances. The ABORT pin may also be used when blade 104 is being hot-swapped, or hot-inserted into the backplane. Here, “hot swap” or “hot insertion” refers to inserting blade 104 into backplane connectors while digital switch 100 is in operation.

Furthermore, it is important to distinguish actual commands from glitches. Typically, during hot insertion, glitches on the control pins are seen. Such glitches normally have a duration of up to about 10 milliseconds or so. Accordingly, commands, if transmitted using control lines (such as the ABORT pin), must be transmitted in a manner that takes account of the glitches. Therefore, preferably, the window for transmission of a pulse train representing a control string is wide enough to filter out any hot insertion glitches. In one embodiment, such a window has a duration of approximately 100 milliseconds, although it will be appreciated that the window may be substantially longer than that. It is also believed that, given a duration of the hot insertion glitches of up to about 10 milliseconds, the window for detection of the pulse train should not be substantially less than 100 milliseconds, and most likely not less than 70-80 milliseconds. However, if for some reason a window shorter than 100 milliseconds has to be used, it is also possible to transmit two (possibly identical) command pulse trains in two consecutive (but separated by a sufficiently long time interval) windows, to minimize the chances of an insertion glitch being mistaken for a command pulse train (command string). Similarly, when more than one command string is to be issued, the commands need to be spaced preferably at least one window size (100 msec apart). Note that in a typical digital switch 100, the window length is hard-wired.

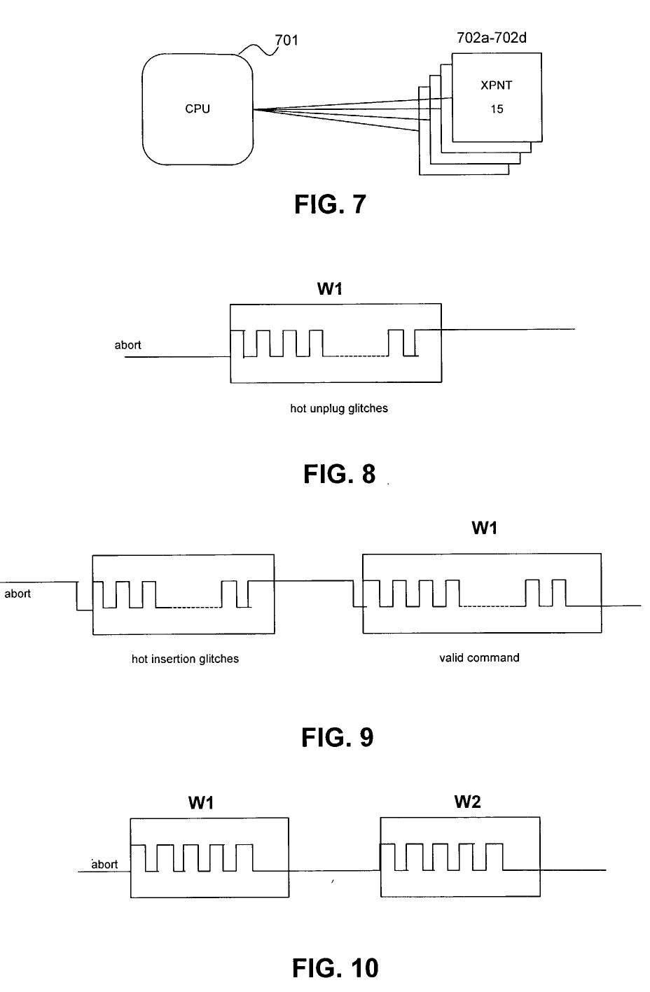

FIG. 7 illustrates a generalized schematic of a XPNT15, which may include four 16-bit slices 702a-702d. The XPNT15 may be controlled by a CPU 701. The CPU 701 may be on a dedicated blade 104, for example, blade 104A, which is used solely as a controller. Thus, in a XPNT15 digital switch 100 (which, logically, is two XPNT8's, e.g., 202A, 202B of FIG. 2), one blade (e.g., blade 104A) may be referred to as the “master blade,” or the “CPU blade,” with the remaining blades used for conventional data processing. Similarly, in a XPNT8 (logically, 202A FIG. 2), blade 104A may be the master blade, with blades 104B-104H used for data transfer.

Due to the fact that all four slices 702a-702d of the XPNT15 in FIG. 6 share the same ABORT signal, all four slices will have the exactly same configuration at any time.

FIG. 8 illustrates an example of hot unplug glitches. As may be seen from FIG. 8, if the ABORT pin is LOW prior to the hot unplug, after the unplug (and after the glitches settle), the ABORT pin is asserted HIGH. This tells digital switch 100 that a particular blade has actually been pulled out of the backplane.

FIG. 9 illustrates a situation when a blade 104 is hot-inserted, and following the hot insertion, the ABORT pin is used to transmit a command. As may be seen in FIG. 9, prior to the hot insertion, the ABORT pin is HIGH. During the process of hot insertion, there may be glitches on the ABORT pin, and when the hot insertion process is complete, the ABORT pin is HIGH again. When the command string begins following the hot insertion, the state of the ABORT pin may change, which is an indication to a processor of digital switch 100 to listen for commands on the ABORT pin. By monitoring the ABORT pin and verifying that the state of the ABORT pin at the end of window W1 is LOW, digital switch 100 recognizes that a valid command has been transmitted during window W1.

Either software or CPU 701 can configure or reset digital switch 100 by sending out-of-band commands through the ABORT signal. Digital switch 100 decodes the out-of-band command by counting the number of ABORT pulses within a 100-millisecond-wide window W1, which begins upon detection of the very first rising edge. At the end of window WI, the ABORT state is also checked to be FALSE (logic “0”) four times. Thus, digital switch 100 can determine if the received pulses may have been glitches caused by “hot swapping” or else a valid command string issued by CPU 701. When blade 104 is being “hot swapped”, the ABORT signal always ends up being asserted HIGH, while for the regular commands, the ABORT signal will be de-asserted (e.g., LOW) by software at the end of the window W1.

FIG. 10 illustrates the situation when two consecutive commands are transmitted during two consecutive windows W1 and W2 using the ABORT pin. As may be seen in FIG. 10, the first command is transmitted during window W1 using the ABORT pin. At the end of window W1, the ABORT pin is reasserted back to LOW. Sometime later, at the beginning of window W2, the ABORT pin is again used to transmit a second command. At the end of window W2, the ABORT pin is again asserted LOW. Digital switch 100 can then execute commands and change its own parameters.

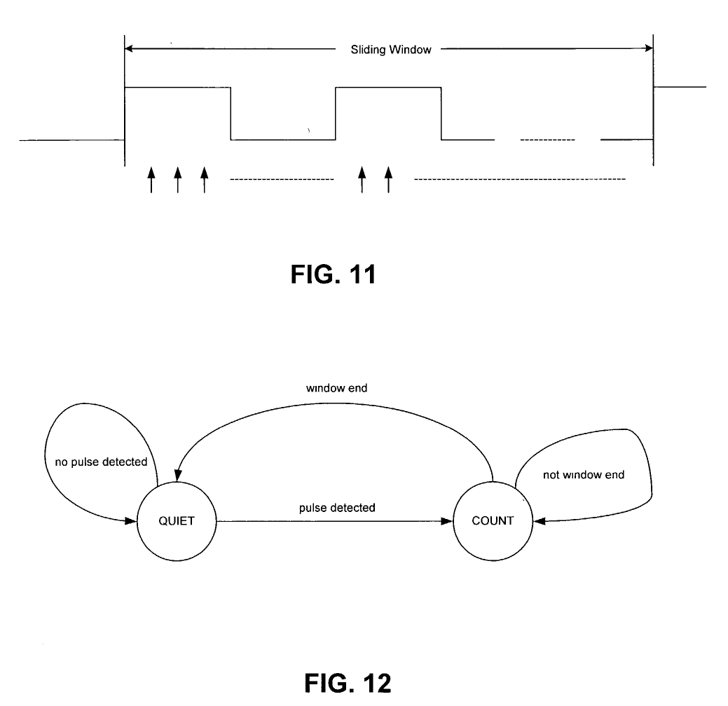

FIG. 12 illustrates the operation of a processor of digital switch 100 implemented as a finite state machine (FSM) using the sliding windows shown in FIG. 11. In one embodiment of the present invention, the FSM may be used to monitor the control line of a backplane used for transmission of out-of-band commands. As may be seen in FIGS. 11-12, when the control pin is in the QUIET state, the FSM cycles through the QUIET state, as long as no pulse is detected on the control pin (e.g., the ABORT pin). If a pulse on the control pin is detected, the FSM goes into a COUNT state, where it counts the pulses received on the control pin. As long as the sliding window does not end, the FSM cycles through the COUNT state, counting the pulses. Once the sliding window ends, the FSM goes back to the QUIET state. For example, if the state of the control pin at the end of the sliding window is different from its state prior to the beginning of the sliding window (i.e., the pin went from HIGH to LOW, or from LOW to HIGH), then the FSM recognizes that a command has been received. If the state of the control pin is the same, then the FSM recognizes that no command was sent, and the changes in the state of the control pin during the window are only glitches.

In other words, the pulse-train command decoding is implemented using a window counter and monitoring FSM, as shown in FIGS. 10A-10B. The monitoring logic enters the COUNT state when the very first “pulse” is detected and then starts the window counter and the pulse counter. Once the end of the window is reached, the pulse number recorded in the pulse counter is used to do the command decoding and in the meantime, the FSM will enter QUIET state, reset the pulse counter and wait for another train of pulses that represents a next command.

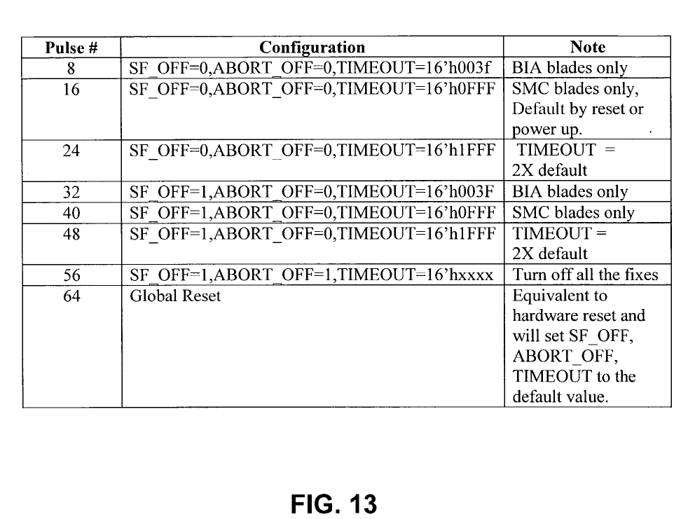

FIG. 13 illustrates examples of various commands that may be transmitted using the control pin, as discussed above. Note in particular the “turn off all the fixes” command (i.e., the “parachute” option), which may be used to reset the arbitration scheme to default, or to reset all the modified parameters to their default state. By default, digital switch 100 should initialize correctly, auto-detect any lockup (for example, due to heavy traffic of occasional jumbo packets of 2K size or greater), and correctly unlock itself (“packet discard”), without any need for software intervention.

In the event that there is an unexpected problem with the arbitration logic, an optional “parachute” mechanism can be managed by software to disable, modify, or tune the deadlock prevention mechanisms as needed (i.e., software “knobs”). Furthermore, for purposes of initial configuration, the added features and the fine-tuned parameters can be turned off, such as, for example, the “timeout” value used to determine the “lockup”.

The number of positive pulses issued by software determines a valid command string, and specifically one of eight unique commands as shown in FIG. 13. The pulse width is irrelevant, so long as the entire command string (up to 64 pulses) can be issued within the window (e.g., within 100 msec).

As indicated in FIGS. 8-10, a “pulse” is defined as a single transition from “LOW” to “HIGH” on the ABORT signal (i.e., the software sets ABORT to logic “0” and then to logic “1”=1 pulse). In addition, in one embodiment, only an integer multiple of eight ABORT pulses, command dependent, must be issued by software. All non-integer pulse strings will result in the entire string being discarded (i.e., invalid command decode).

Note that as hardware begins the 100 msec countdown upon detection of the first rising edge, it is important that software assert the final state of ABORT logic “0” (LOW) immediately following the command string. Failure to do so may result in hardware discarding a previously issued, and potentially valid, command string.

Digital switch 100 has a number of deadlock prevention mechanisms, such that the lockup is entirely eliminated for regular sized packets, and substantially reduced for jumbo-sized packets. See also discussion of deadlock prevention in related application Ser. No. ______ , filed on even date herewith, entitled CROSS POINT SWITCH WITH DEADLOCK PREVENTION, Inventors: Ming Wong and Xiaodong Zhao, Attorney Docket No. 1988.0130000, which is incorporated by reference herein. For those cases where the lockup event cannot be avoided, digital switch 100 will auto detect this and unlock itself by discarding one packet.

By default, the “store and forward” and “lockup abort” are enabled. The default “lockup timer” is set to the maximum round-trip latency that would result in a fully-loaded XPNT15 chassis.

Based on a number of ABORT pulses within a 100-millisecond sliding window, there may be at least two types of commands (see FIG. 13):

Global reset command (# of ABORT pulses=64; same effect as power-on)

Configuration command (# of ABORT pulses=8, 16, 24, 32, 40, 48, 56)

Except for the “global reset” command, the other “configuration” commands are per port based. The commands issued by a given blade 104 ABORT signal can only initialize the particular port corresponding to that blade 104.

The following parameters are representative of switch parameters that may be fine-tuned, although it will be appreciated that the invention is not limited to these particular parameters:

Input FIFO thresholds: this parameter refers to effective FIFO depth indicating when the FIFO is filled up. Typically, effective FIFO depth is FIFO size (for example, 2K) reduced by a number of bytes that is related to the latency of the system. For example, 40 cycles and 8 bytes (i.e., 64 bit wide data path) is equivalent to 320 bytes in a 64-bit wide cross point and 133 MHz clock. Thus, effective FIFO threshold (depth), in this case, is 2048−320=1728 bytes. However, effective FIFO depth may be either increased or decreased, if required, by using the control pin to transmit an appropriate command.

Lockup Timeout threshold: another parameter that may be fine tuned is the lockup time out threshold, which is normally defaulted to digital switch 100 latency time. The length of time the digital switch 100 waits before recognizing a lockup condition therefore may be increased or decreased.

Arbitration scheme selection may be changed in response to the control pin signal, such as, for example:

Store and forward arbitration may be either enabled or disabled. For example, if it is known that the nature of the traffic is such that only small sized packets are being transmitted, the store and forward arbitration may be unnecessary, and can be disabled.

Cut-through arbitration is normally used for small-sized packets. If it is known that the nature of the data traffic is such that only packet-based arbitration should be performed, then cut-through arbitration can be disabled.

Round-robin arbitration: as with other arbitration schemes, round-robin arbitration may be enabled or disabled, using the out of band command, as discussed above.

Strict Priority arbitration: another arbitration option is a strict priority arbitration. In this case, the strict priority arbitration refers to a situation where a particular port has absolute priority over all the others in the arbitration scheme.

Arbitration weight value may also be modified as follows:

Packet priority based: optionally, the packet itself may have information in its header that indicates priority. Thus, depending on the priority information in the packet header, the arbitration weight value may be modified to take packet priority into account.

Port-based: each individual port may also have a priority weight assigned to it. Thus, for example, port 1 may have priority 1, entitling it to, for example, 10 transmission slots. Port 2 may have priority 2, for example, entitling it to 5 transmission slots, port 3 may have priority 3 entitling it to 2 transmission slots, etc.

It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method of fine tuning a digital switch comprising the steps of:
monitoring a control line of the digital switch;
detecting a change in a state of the control line;
analyzing the state of the control line to detect a command within a predetermined time window; and
modifying a parameter of the digital switch in response to the command.

2. The method of claim 1, wherein the modifying step comprises the step of modifying FIFO depth threshold.

3. The method of claim 1, wherein the modifying step comprises the step of modifying a store and forward arbitration parameter.

4. The method of claim 1, wherein the modifying step comprises the step of modifying a cut-through arbitration parameter.

5. The method of claim 1, wherein the modifying step comprises the step of selecting an arbitration mode.

6. The method of claim 1, wherein the modifying step comprises the step of changing a lockup timeout threshold.

7. The method of claim 1, wherein the modifying step comprises the step of changing an arbitration weight value.

8. The method of claim 1, wherein the state of the control line at an end of the window is different than the state of the control line at the beginning of the window.

9. The method of claim 8, wherein the window is substantially longer than a hot insertion glitch.

10. The method of claim 9, wherein the command is a serial pulse train received over the control line.

11. The method of claim 10, wherein the command comprises restoring default parameters of the digital switch.

12. The method of claim 11, wherein the window is substantially longer than a hot insertion glitch.

13. The method of claim 1, wherein the window is at least 100 msec long.

14. The method of claim 1, wherein the window is substantially longer than a hot insertion glitch.

15. The method of claim 1, wherein the control line is an ABORT pin.

16. The method of claim 1, wherein the command is a serial pulse train received over the control line.

17. The method of claim 1, wherein the command is received over multiple control lines.

18. The method of claim 1, wherein the command comprises restoring default parameters of the digital switch.

19. A digital switch comprising:
a switching fabric that routes data traffic between a plurality of ports and includes data lines and a control line;
an arbitrator that arbitrates the data traffic between the plurality of ports; and
a command processor that receives a command over the control line and modifies a parameter of the switching fabric in response to the command.

20. The digital switch of claim 19, wherein the command comprises modifying FIFO depth threshold.

21. The digital switch of claim 19, wherein the command comprises modifying a store and forward arbitration parameter.

22. The digital switch of claim 19, wherein the command comprises modifying a cut-through arbitration parameter.

23. The digital switch of claim 19, wherein the command comprises an arbitration mode selection.

24. The digital switch of claim 19, wherein the command changes a lockup timeout threshold.

25. The digital switch of claim 19, wherein the command comprises an arbitration weight value.

26. The digital switch of claim 19, wherein a state of the control line at an end of a monitored window is different than a state of the control line at the beginning of a monitored window.

27. The method of claim 26, wherein a monitored window is substantially longer than a hot insertion glitch.

28. The method of claim 27, wherein the command is a serial pulse train received over the control line.

29. The method of claim 28, wherein the command comprises restoring default parameters of the digital switch.

30. The method of claim 29, wherein a monitored window is substantially longer than a hot insertion glitch.

31. The digital switch of claim 30, wherein the command is an out-of-band command.

32. The digital switch of claim 19, wherein a monitored window for receiving the command is at least 100 msec long.

33. The digital switch of claim 19, wherein a monitored window for receiving the command is substantially longer than a hot insertion glitch.

34. The digital switch of claim 19, wherein the control line is an ABORT pin.

35. The digital switch of claim 19, wherein the command is a serial pulse train.

36. The digital switch of claim 19, wherein the command is received over multiple control lines.

37. The digital switch of claim 19, wherein the command restores default parameters of the digital switch.

38. The digital switch of claim 19, wherein the command is an out-of-band command.

39. The digital switch of claim 19, wherein the command processor is a finite state machine.

40. A digital switch comprising:
a plurality of ports connected to a switching fabric using data lines and a control line;
an arbitrator that arbitrates data traffic between the plurality of ports; and
a finite state machine that monitors the control line and modifies a parameter of the switching fabric in response to a command received over the control line.

41. The digital switch of claim 40, wherein the command corresponds to any one of: modifying FIFO depth threshold, modifying a store and forward arbitration parameter, modifying a cut-through arbitration parameter, an arbitration mode selection, changing a lockup timeout threshold, changing an arbitration weight value, and restoring default parameters of the digital switch.

42. The digital switch of claim 40, wherein the finite state machine monitors a state of the control line during a time window, and
wherein the state of the control line at an end of the time window is different than a state of the control line at the beginning of the time window.

43. The method of claim 42, wherein the time window is substantially longer than a hot insertion glitch.

44. The method of claim 43, wherein the command is received serially over the control line.

45. The digital switch of claim 40, wherein the control line is an ABORT pin.

46. A digital switch comprising:
a switching fabric connected to a plurality of ports with data lines and a control line; and
an arbitrator that arbitrates data between the plurality of ports,
wherein the switching fabric modifies at least one of its parameters in response to a command received over the control line.

47. The digital switch of claim 46, wherein the command corresponds to any one of: modifying FIFO depth threshold, modifying a store and forward arbitration parameter, modifying a cut-through arbitration parameter, an arbitration mode selection, changing a lockup timeout threshold, changing an arbitration weight value, and restoring default parameters of the digital switch.

48. The digital switch of claim 46, wherein the finite state machine monitors a state of the control line during a time window, and
wherein the state of the control line at an end of the time window is different than a state of the control line at the beginning of the window.

49. The method of claim 48, wherein the time window is substantially longer than a hot insertion glitch.

50. The method of claim 49, wherein the command is received serially over the control line.

51. The digital switch of claim 46, wherein the control line is an ABORT pin.

52. A method of fine tuning a digital switch comprising the steps of:
monitoring a state of a control line from a blade to the digital switch;
detecting a change in the state of the control line;
detecting an out-of-band command transmitted over the control line within a predetermined time window; and
modifying a parameter of the digital switch based on the out-of-band command.
